(19) United States
(12) Patent Application Publication
(10) Pub. No.: US 2006/0134293 A1
(43) Pub. Date: Jun. 22, 2006

(54) Food preparation method, composition and method of conducting bussiness

(76) Inventor: Don Wehmeyer, Puyallup, WA (US)

Correspondence Address: John P. Luther, Jenkens & Gilchrist, 225 W. Washington Street, Suite 2600, Chicago, IL, 60606, US

(21) Appl. No.: 11/018,277

(22) Filed: Dec. 21, 2004

(51) Int. Cl. A23L 1/236

(52) U.S. Cl. 426/548

(57) ABSTRACT

The present invention provides products and methods for the high temperature preparation of cooked food products, and more particularly the employ of xylitol as a food preparation medium.

### FIELD OF THE INVENTION

The present invention relates to methods and compositions for the high temperature preparation of cooked food products, and methods of conducting business thereby.

### BACKGROUND OF THE INVENTION

A portion of the disclosure of this patent application/patent document contains material which is subject to copyright protection. The copyright owner has no objection to the facsimile reproduction by anyone of the patent document or the patent disclosure as it appears in the United States Patent and Trademark Office files and records.

The food products and food service industry has seen explosive growth in recent years. Whether it be new and innovative food preparation methods and products for home use or for commercial application in restaurant or plant operations, the food preparation and service industry is booming. A common theme runs through most if not all emerging methods and applications, however, which is improved health consciousness with respect to ingredients and materials employed.

As some commentators have observed, a large percentage of the daily caloric intake, for instance in the typical American diet, is in the form of fats or triglycerides, which are digested through hydrolysis and subsequent absorption. On average, more triglycerides or fat are consumed than are actually needed for proper nutrition. The large proportion of the public that is overweight, or in many cases obese, is thought to be at least in part due to the dramatically high increases in fast food consumption or restaurant outings with excessive fat intake, and which in turn contributes to a variety of health problems and concerns. Indeed, a great majority of present day snack products, and other restaurant and prepared foods, are known to contain a high level of fat, which is present in the form of either separately added ingredients or in the form of fats imparted to a product during cooking, as in the case of, for instance, corn or potato chips or deep fried foods such as doughnuts, french fries and fried chicken. Additionally, excessive fat consumption will equal excessive caloric intake, as fats have double the caloric density of proteins and carbohydrates.

Thus, an entire industry has been developing to provide for low or lower fat food products and methods for preparing foods, especially in the fast food and snack industries. A major drawback or hindrance, however, has been the less than acceptable quality of taste and mouth feel of such products, or the poor performance, and sometimes danger, of using reduced fat products, or alternative products, in food preparation, such as in frying and heating mediums and the like.

For example, there is disclosed in U.S. Patent Application Publication No. 2003/0215556, reduced caloric fat compositions which contain combinations of substantially non-absorbable, substantially non-digestible polyol polyesters and certain reduced calorie triglycerides. These compositions are said to function as anti-anal leakage agents and provide texture/taste benefits, and are useful in a variety of food applications, including frying oils, cooking and salad oils. As explained, the polyol polyesters employed in the edible compositions provide for minimal or fewer calories as they are largely non-digestible and non-absorbable. The reduced calorie triglycerides, however, are said to have low smoke, flash and firepoint temperatures compared, for example, to soybean oil, as well as foaming and auto-ignition problems when used in cooking and frying applications. While such problems are somewhat overcome by the admixture of triglycerides with polyol polyesters which have higher smoke, flash and fire-point temperatures, it is believed that such inherently dangerous properties are never entirely eliminated when using such materials in high temperature food preparation.

In U.S. Pat. No. 5,922,386 there is disclosed a process for preparing reduced fat snack products made from dough and fried in non-digestible fats. The process comprises first forming a dough shape from a source of starch-based flour which contains hydrolyzed starches having a D.E. value, or measure of the reducing equivalence of the hydrolyzed starch referenced to dextrose, from about 5 to about 30 percent of a fatty acid polyglycerol ester emulsifier with particular saponification hydroxyl values, and in which the fatty acids comprise mostly palmitic and stearic acids with specified palmitic to stearic acid ratios and an amount of polyglycerol ester which is mono-ester. As also described, the polyol polyester with polyglycerol emulsifier-containing formulation is said to provide for a lower water level dough which lead to fried snack products which contain less fat than those made with corresponding conventional doughs with higher water levels, with the inclusion of hydrolyzed starches in the product improving the flavor of the snack. However, employing a polyol fatty acid polyester as a fat substitute is not seen as particularly desirable for long-term health concerns, as recent emphasis in the prepared food industry is to employ natural products.

U.S. Pat. No. 5,494,693 discloses compositions for use as high temperature mediums with increased stability for par-frying or deep fat frying applications. These compositions are said to contain C₁₂-C₂₄ fatty acid ester of glycerin with a particular iodine number, and which may be a lipid derived from a vegetable, animal or marine source, and an aliphatic ether. The aliphatic ether may be a polyether having oxyalkylene repeating units, such as esterified alkoxylated polyol or a saturated aliphatic poly ether with repeating units selected from oxyethylene, oxytrimethylene, oxypropylene, oxytetramethylene and oxybutylene. Additionally, the aliphatic ether may be an esterified alkoxylated polyol, and the polyol may contain at least two hydroxyl groups and be alkoxylated with a C₂-C₁₂ cylic ether, and the resulting alkoxylated polyol esterified either fully or partially derivatized with a carboxylic acid or carbokylic acid derivative. Some suitable polyols are said to be ethylene glycol, propylene glycol glycerin and sugar alcohols, such as xylitol, erythrital, monnitol, sorbital, monosaccarides, such as xylose, arabinose, ribose, glucose, and fructose and the like. As also disclosed, there are provided compositions of an esterified propoxylated glycerin and an edible lipid, such as vegetable oil, which are said to be useful as reduced calorie high temperature cooking media with enhanced thermal stability.

In U.S. Pat. No. 5,534,284, there are disclosed non-digestible fat compositions said to be useful as replacements for triglyceride fats and oils in food products, and in cooking and frying oils, and which also rely on the use of polyol polyesters. These compounds can be prepared by transesterification of a polyol, such as a sugar or sugar alcohol, with methyl, ethyl or glycerol esters, acylation of a polyol with a acid chloride or acid anhydride or acid.

U.S. Pat. No. 5,427,815 also discloses reduced calorie fat substitutes or “fat” mimetics” and which contain esterified alkoxylated polyols containing polycarboxylate linking segments. These compositions are said to be useful fat substitutes for triglyceride lipids with food preparation applications in cooking oil, frying oil, salad oil or shortening, and which are also useful to from food compositions such as frozen deserts and baked goods, such as cakes, doughnuts and the like, and diary products, such as sour cream, coffee lighteners and the like. The linked esterified alkoxylated polyol comprises a polycarbonyl linking segment, at least two polyol segments and at least one C₆-C₂₄ monocarboxylic fatty acid-esterified oxyalkylene segment attached to a polyol segment in which each polyol segment is connected to the polycarbonyl linking segment either directly or through an oxyalkylene segment.

All of the above-described reduced fat, or substituted fat food preparation compositions, and/or processes are undesirable, however, in that they impart a highly processed element to foods with an exclusive reliance on non-natural ingredients, which are undesirable and preferably avoided in recent times for health reasons. These products and methods also suffer from poor smoke and flash properties and in some cases auto-ignition problems.

It would be therefore highly desirable to provide a reduced fat, or non-fat alternative composition and method for the preparation of food products which imparts only natural substances to food products, and which may be used safely at the high temperatures required for the preparation of any type of food product, especially fried or deep fried products.

### SUMMARY OF THE INVENTION

In accordance with that set forth above, the present invention provides a novel food product preparation method and product, comprising the use of xylitol as a high temperature medium for food product preparation, especially for pan and deep frying applications.

The invention is more fully understood by the reference to the following Detailed Description of Preferred Embodiments.

### DETAILED DESCRIPTION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

As used herein the terms “cooked” and/or “high temperature prepared” refer to procedures wherein food products are treated with heat prior to their consumption, such as, for example, by par-frying or deep frying, baking, broiling, micro-waving, heating in a toaster oven and the like, and oftentimes reducing the moisture content of the food product.

The terms “fat” or “oil” as used herein, and which are intended to be used interchangeably, refer to edible substances fit for human consumption in a general sense, including natural or synthetic fats or oils which may comprise triglycerides, such as, for example, soybean oil, corn oil, cottonseed oil, canola oil, sunflower oil, palm oil, coconut oil, fish oil, lard and tallow, and which may have been partially or completely hydrogenated, modified or otherwise, as well as non-toxic fatty materials having properties similar to triglycerides, or sometimes called “fat substitutes”, and which may be partially or fully digestible by humans or animals.

As used herein, the term “finished” refers to a food product which has been subjected to a cooking process, such as frying, oven baking, micro-waving and the like, to convert it to a ready-to-eat form.

As used herein, the terms “conditioned oil or “conditioned medium” refer to oil or a medium which as been previously used for frying, either deep or par-frying, for such a time that it has developed fried food flavor.

As used herein, the terms “par-fry” or par-cooked” refer to food products which have been subjected to at least one frying or cooking process, such as, for example, deep frying, but which have not been completely cooked or finished.

As used herein, the term “oven finishing” refers to par-fried or par-cooked food products which may be fully cooked or finished at some later time by heat application.

Xylitol is a well known, naturally occurring sugar alcohol of the formula:
(Formula of Xylitol)

In accordance with the present invention, it has been unexpectedly found that xylitol my be used as a high temperature medium in place of, or in combination with, fats and/or oils to produce finished or par-fried or par-cooked food products substantially reduced in fat that would be imparted thereto by conventional processes.

Xylitol, which is found in many fruits and vegetables and in the human body, is primarily noted for its effectiveness in dental applications and for its efficacy in the reduction of dental caries, in the reduction of plaque for fighting tooth decay, bad breath, infections, and is used as a natural replacement for fluoride. Xylital also has a unique ability to combine antibacterial action with great taste. It is also used as a substitute sweetener for sucrose, and has also found use for its humectant properties in products such as toothpaste where it prevents plugging of uncapped tubes. See, for example, International Application No. PCT/F191/00313 9206943. However, heretofore it has not been known as a viable fat-free, high temperature medium for food product preparation.

Xylitol is a natural product which can be isolated from trees and other vegetation, such as corn cobs and other renewable sources. In commercial production typically wood is hydrolyzed, the residue separated out, and the remaining hydrolysate is hydrogenated followed by a series of stages in which xylitol is crystallized and separated out by centrifugation. After one or more crystallization and centrifugation steps, the “run-off” or the remaining liquid containing non-crystallized xylitol as well as other polyols, usually contains about 70% dry solids, of which 90-90% is xylitol. A typical composition of xylitol run-off is described, for example, in International Application No. PCT/F191-00313 9206943.

Other procedures for xylitol production are known, such as from a culture medium. As disclosed for example, in U.S. Pat. No. 6,538,133, a process for producing xylitol of high purity is discussed comprising the steps of (1) removing solid matter from a culture froth obtained by culturing a xylitol-producing microorganism in an aqueous culture medium, (2) desalting the resulting solid matter—removed culture broth by removing the ionic substances therefrom by means of a cation-exchange resin and an anion-exchange resin, (3) subjecting the resulting desalted solution to chromatography using a strongly acidic cation-exchange resin to separate the xylitol form the other sugar alcohol(s) and sugar(s), and (4) obtaining the xylitol by separating it at a high purity from the resulting xylitol solution fraction, and next carrying out a similar process (two-step desalting process) in which the desalting is twice carried out by adding the ion-exclusion step between steps (1) and (2) above to remove most of the ionic substances. This process produces high purity xylitol from a xylitol solution in a commercially effective manner.

In any event, the present invention contemplates the employ of xylitol produced from any conventional or non-conventional method or process. Preferably, the xylitol used herein may be obtained by dissolving and/or melting crystalline xylitol, which is preferably substantially pure and obtained by hydrogenation of crystalline xylose.

The xylitol employed in the present invention may be used as a high temperature food product preparation medium in continuous or batch frying operations, or in a non-constrained mode in which food product pieces are immersed in fat or oil, or in the present invention, in xylitol in heated liquid form, or a combination thereof with conventional oils and fats, on a moving belt or basket.

As in some conventional operations, food product pieces may be fried to reduced moisture content of, say, 10% or less, and then heated with hot air, superheated steam or some inert gas to further lower moisture levels, in a combined or hybrid frying/baking step.

It is also contemplated herein that the xylitol may be applied to food products to be cooked, finished or par-cooked as a mist or foam coating and the like, for subsequent application of heat in a cooking environment, such as in oven baking or oven finishing.

The employ of xylitol herein is contemplated to be a complete or at least partial replacement for the conventional high caloric triglyceride oils and/or synthetic substitutes used as frying oils or heat transfer media in the preparation of fried and/or prepared, finished and/or par-cooked foods such as salted snacks, such as potato chips, corn chips, tortilla chips, cheese curls or puffs, potato sticks, French fries, fried meats, such as chicken, turkey, shrimp, breaded fish or chicken patties, fried pastries and deserts, such as doughnuts, turnovers, crullers, in addition to any other edible food composition prepared by using any frying technique, or combination frying and baking technique, or baking to simulate frying technique.

It is further contemplated that the inventive xylitol composition may be imparted with any properties desired, or employed alone or in combination with any of the myriad of additives known, such as flavorants, emulsifiers, stabilizers, conventional fats and lipids or low calorie fat substitutes or fat mimetics, for instance, polyol fatty acid polyesters and the like.

Additionally, in some embodiments in preparation of food products, a degree of sweetness imparted to a food product may desired to be lessened or reduced. In such instances it has been found that the addition of a salt, such as sodium or potassium chloride, or other edible salts, to xylitol used as a heating or frying medium will reduce or counteract the degree of sweetness as desired.

In still other embodiments, it is contemplated to employ a degree of pressure to the Xylitol as used as a heating and/or frying medium, such as in pressure cooking embodiments, for instance, in the preparation of pressure cooked fried chicken.

The following examples further illustrate the present invention, but are not intended to limit the scope of the invention or appended claims in any manner.

### EXAMPLES

1. Preparation of Cake Doughnuts

In the preparation of doughnuts, sugar may be substituted in the dough with xylitol, or if desired, dough may be prepared without any sugar or xylitol or other sweetener, as taste preference and/or diet dictates. A shortening product may also be dispensed with, or if desired, replaced with a low-fat or non-fat substitute, such as described above.

The dough is mixed in a conventional procedure, and then placed in a frying container filled with xylitol, crystalline xylitol which as been heated to about 350° F. to about 400° F., and then fried on each side for about 60-100 seconds, or until a finished product is produced, depending on such considerations as the recepie employed and the like. The finished product is then removed from the fryer and placed on a drain rack, optionally in a heated enclosure at, say 350° F. to allow excess xylitol to drip away.

2. Preparation of Raised Doughnuts

The same procedure as described is carried out, except that yeast is employed in dough, and may require the presence of some sugar for the production of CO_{2 .} Baking soda, or a combination of baking soda and yeast may be employed, or any conventional recepie or technique may be employed as desired,

3. Glaze

Xylitol is available commercially as confectionary xylitol in similar manner as confectionary sugar. It may be mixed with milk, butter and flavoring to make a cold glaze, which can be applied to such products as described above.

4. Meat Cooking

All different types of meats, such, for example, as chicken, salmon, Chinese dumplings on wantons prepared with a meat and other ingredients inside, such as veggies, shrimp, and a whole chicken and chicken parts, or a whole turkey may be cooked in xylitol. For thicker meats, a temperature of from, say, 320° F. to about 375° F. may be employed, as thicker meats may require a lower temperature for a longer frying time. As in any conventional process, meats fried in xylitol may be seasoned prior to frying. Frying time will depend, of course, on the thickness of the food product undergoing cooking, and whether it is frozen or at ambient temperature. Meats prepared with batter, such as, for instance, sweet and sour pork, may also be fried in xylitol

5. Vegetable Preparation

Frozen or fresh French fries are ideally cooked in xylitol, and may be imparted with a sweet taste, or without as per the addition of salt, such as sodium or potassium chloride. The same cooking times as that of oil or fat are required, such as for french fries preparation in xylitol. In other embodiments, other vegetables may be fried or stir fried in xylitol, or dipped in batter and fried.

6. Whole Turkey Preparation

Whole turkeys, or other foul, may be fried in xylitol in the same manner as conventionally preformed in fat or oil, but without imparting needless extra fat and calories and being left with vat full of grease waste. For example, in operation, a 6-10 lbs turkey may be fried in a conventional turkey fryer filled with heated xylitol in place of oil or fat, and cooked accordingly.

It will also be appreciated by those skilled in the art that the present inventive method and product affords distinct business advantages not previously available to manufactures, distributors and purveyors of prepared food products. In this aspect the present invention provides for novel methods of conducting an array of business functions comprising designing, manufacturing, using, marketing, selling, licensing, and/or leasing the inventive subject matter, or of developing business good will, and further providing novel methods for business entity formation, such as partnerships and corporations for conducting the business of the invention.

While the invention has been described in connection with what is presently considered to be the most practical and preferred embodiments, it is to be understood that this invention is not to be limited to the disclosed embodiments in any way and which are merely set forth for illustrative purposes only. The present inventive method and system, and method for conducting business in general, is intended to cover an array of various modifications and equivalent arrangements, all of which are contemplated for inclusion within the scope and spirit of the disclosure and the appended claims.

1. A composition suitable for use as a high temperature reduced calorie cooking medium comprising xylitol.

2. The composition of claim 1 further comprising a portion of oil or fat.

3. The composition of claim 1 further comprising a fat substitute.

4. The composition of claim 2 further comprising a fat substitute.

5. The composition of any of claims 1, 2, 3, and 4 which further comprises an additive selected from flavorants, emulsifiers, stabilizers, antioxidants, water and/or other sugars or alcohol sugars.

6. The composition of claim 1 which is useful for preparing finished or par-fried food products selected from potato chips, corn chips, tortilla chips, cheese curls, cheese puffs, potato sticks, french fries, fired meats, including fried chicken, turkey, shrimp, breaded fish products, including fish sticks and patties, fried pastries and desserts and fried vegetables.

7. A reduced calorie food product prepared from frying or par-frying in xylitol or a composition comprising xylitol.

8. A reduced calorie food product prepared from frying or par-frying in a composition comprising xylitol, and optionally a fat or oil and/or a fat substitute.

9. A process for frying a food product comprising the use of xylitol as a high temperature frying medium for preparing finished or par-fried product.

10. The process of claim 9 further comprising the use of xylitol under pressure.

11. A process for preparing a finished or par-finished food product comprising applying a coating or partial coating of xylitol or a composition comprising xylitol to the food product, and then oven finishing the food product.

12. A cooking system comprising cooking apparatus and the composition of claim 1.

13. A cooking system comprising cooking apparatus and the composition of claim 2.

14. A cooking system comprising cooking apparatus and the composition of claim 3.

15. A cooking system comprising cooking apparatus and the composition of claim 4.

16. A cooking system comprising cooking apparatus and the composition of claim 5.

17. A cooking system comprising cooking apparatus and the composition of claim 6.

18. A process for the preparation of the composition claim 1.

19. A process for the preparation of the composition claim 2.

20. A process for the preparation of the composition claim 3.

21. A process for the preparation of the composition claim 4.

22. A process for the preparation of the composition claim 5.

23. A process for the preparation of the composition claim 6.

24. A process for preparing a food product of claim 7.

25. A process for preparing a food product of claim 8.

26. A method of conducting a business function comprising one or more business activities selected from designing, manufacturing, using, marketing, selling, licensing, leasing, generating business good will, generating trademark rights, and forming and operating a business entity and the use of the composition of claim 1.
